(19) United States
(12) Patent Application Publication
(10) Pub. No.: US 2026/0009260 A1
(43) Pub. Date: Jan. 8, 2026

(54) DEADBOLT, LOCK DEVICE AND SYSTEM

(71) Applicant: ASSA ABLOY AB, Stockholm (SE)

(72) Inventor: Erik Holst-Larsen, Oslo (NO)

(21) Appl. No.: 18/873,547

(22) PCT Filed: Jun. 1, 2023
(86) PCT No.: PCT/EP2023/064697

§ 371 Date: Dec. 10, 2024

(30) Foreign Application Priority Data
Jun. 17, 2022 (SE) 2250734-7

(51) Int. Cl. E05B 15/10; E05B 63/00

(52) U.S. Cl. CPC E05B 15/10; E05B 63/0017

(57) ABSTRACT

A deadbolt comprising a base body; a first ridge for frictionally sliding against a first lock device opening side, the first ridge protruding from a first base side and being parallel with an actuating direction; a second ridge for frictionally sliding against a second lock device opening side, the second ridge protruding from a second base side and being parallel with the actuating direction; at least one first inclined section for frictionally sliding against a first strike opening side, the at least one first inclined section protruding from the first base side separately from the first ridge, and being inclined towards an end; and at least one second inclined section for frictionally sliding against a second strike opening side, the at least one second inclined section protruding from the second base side separately from the second ridge, and being inclined towards the end.

### TECHNICAL FIELD

The present disclosure generally relates to deadbolts. In particular, a deadbolt for a lock device, a lock device comprising a deadbolt, and a system comprising a lock device and a strike, are provided.

### BACKGROUND

A typical lock case may comprise a latch and a deadbolt. The latch may be retracted by a handle but also allows e.g. a door leaf to be closed without maneuvering the handle. The deadbolt may be operated by a key on one side and by a twist knob on the opposite side. A deadbolt may also be operated electronically. When the deadbolt extends to engage a strike in a frame, the door leaf is locked. Lock cases comprising an automatic deadbolt lock are also previously known.

WO 2021058253 A1 discloses a lock device for installation in an access member movable relative to a frame. The lock device comprises a bolt movable between a retracted position and an extended position; a bolt force device arranged to force the bolt from the retracted position towards the extended position; a blocking member movable between a blocking position and an unblocking position; a lock device magnet movable between a passive position and an active position in response to a repulsive magnetic force; and a release transmission arranged to mechanically transmit a movement of the lock device magnet from the passive position to the active position, to a movement of the blocking member from the blocking position to the unblocking position. The bolt may be a deadbolt.

### SUMMARY

A door leaf comprising a lock case having a deadbolt may be subjected to relatively high side forces. In some installations, side forces acting on the door leaf may correspond to 750 kg. Such side forces may for example originate from wind, a non-vertical orientation of the door leaf, manual forces and/or forces from a door closer or door operator. Since frictional forces acting on the deadbolt when moving in a retracting direction (and in an actuating direction) increase substantially proportionally to the side forces, such side forces might deteriorate movability of the deadbolt or even prevent the deadbolt from moving.

One object of the invention is to provide an improved deadbolt.

A further object of the invention is to provide an improved lock device comprising a deadbolt.

A still further object of the invention is to provide an improved system comprising a lock device and a strike.

These objects are achieved by the device according to appended claim 1, the lock device according to appended claim 6 and the system according to appended claim 11.

The invention is based on the realization that by providing a deadbolt comprising first and second ridges constituting frictional interfaces to sides of a lock device opening but that are prevented from contacting sides of a strike opening, and inclined sections for engaging sides of the strike opening but that are prevented from contacting sides of the lock device opening, the deadbolt can make low friction movements from an extended position to a retracted position along an actuating direction even if the deadbolt is not centered with respect to the lock device opening and the strike opening.

According to a first aspect, there is provided a deadbolt for a lock device, for moving in an actuating direction in a lock device opening of the lock device and into a strike opening of a strike, the deadbolt comprising a base body having a first base side, a second base side opposite to the first base side, and an end for facing the strike opening; a first ridge for frictionally sliding against a first lock device opening side of the lock device opening, the first ridge protruding from the first base side and being parallel with the actuating direction; a second ridge for frictionally sliding against a second lock device opening side of the lock device opening, the second ridge protruding from the second base side and being parallel with the actuating direction; at least one first inclined section for frictionally sliding against a first strike opening side of the strike opening, the at least one first inclined section protruding from the first base side separately from the first ridge, and being inclined towards the end; and at least one second inclined section for frictionally sliding against a second strike opening side of the strike opening, the at least one second inclined section protruding from the second base side separately from the second ridge, and being inclined towards the end.

Due to the first and second ridges, an interface of very low friction can be provided to sides the lock device opening while enabling the inclined sections to not contacting any side of the lock device opening. The low friction is advantageous when retracting the deadbolt. The first and second ridges provide a good linear bearing inside the lock device. When the first ridge contacts the first lock device opening side, the second ridge may be separated from second lock device opening side and vice versa. Alternatively, both the first ridge and the second ridge may always be in contact with the first lock device opening side and the second lock device opening side, respectively. Also in this way, a good linear bearing can be provided. The at least one first inclined section and the at least one second inclined section on the other hand enable contact with a respective strike opening side while enabling the first and second ridges to not contacting any side of the strike opening. When the first inclined section contacts the first strike opening side, the second inclined section may be separated from the second strike opening side, and vice versa. Alternatively, the first inclined section may contact the first strike opening side at the same time as the second inclined section contacts the second strike opening side.

The first lock device opening side may be arranged opposite to the second lock device opening side with respect to the deadbolt. The deadbolt may thus be arranged between the first and second lock device opening sides.

The first strike opening side may be arranged opposite to the second strike opening side with respect to the deadbolt. The deadbolt may thus be arranged between the first and second strike opening sides.

The low friction for the deadbolt can obtained without using rollers. Thus, the deadbolt is more compact and cost efficient in comparison with a bolt having rollers.

The first ridge may be centered on the first base side and the second ridge may be centered on the second base side. Alternatively, or in addition, each of the first and second ridges may be curved in a plane transverse to the actuating direction. Each of the at least one first inclined section and the at least one second inclined section may be flat or conical.

Each of the at least one first inclined section and the at least one second inclined section may be inclined less than 40 degrees, such as less than 20 degrees, such as less than 10 degrees, to the actuating direction in a plane comprising the actuating direction and a transverse direction transverse to the actuating direction.

The at least one first inclined section may comprise two first inclined sections. The first inclined sections may be parallel with each other.

Correspondingly, each of the at least one second inclined section may comprise two second inclined sections. The second inclined sections may be parallel with each other.

The first ridge may be positioned between the two first inclined sections. The first ridge may be centered between the two first inclined sections.

Correspondingly, the second ridge may be positioned between the two second inclined sections. The second ridge may be centered between the two second inclined sections.

The deadbolt may comprise steel. The deadbolt may for example be made of steel.

According to a second aspect, there is provided a lock device for installation in an access member movable relative to a frame comprising the strike, the lock device comprising the lock device opening and the deadbolt according to the first aspect. Throughout the present disclosure, the lock device may be a lock case.

The access member may be rotatable relative to the frame. The access member may for example be a door leaf or a window.

The lock device may comprise a forend. In this case, the lock device opening may be provided in the forend. The deadbolt may protrude at least 2 cm, such as 2.54 cm (an inch), from the forend in an extended position.

The at least one first inclined section may be arranged to be separated from the first lock device opening side when the first ridge contacts the first lock device opening side. Conversely, the at least one second inclined section may be arranged to be separated from the second lock device opening side when the second ridge contacts the second lock device opening side.

The deadbolt may be movable from an extended position for engagement with the strike and a retracted position for disengagement from the strike. In this case, the lock device may further comprise a deadbolt force device arranged to force the deadbolt from the retracted position towards the extended position. The deadbolt force device may be a spring. A force stored in the deadbolt force device may be triggered to be released when a door leaf reaches a frame, for example by magnetic triggering. When the force in the deadbolt force device is released, the deadbolt force device forces the deadbolt from the retracted position to the extended position.

The strike may comprise steel.

The lock device may comprise only one member, i.e. the deadbolt, arranged to protrudingly engage with the strike (e.g. entering the strike opening of the strike). For this reason, the lock device may be referred to as a single bolt lock device. For example, the lock device may be a lock case comprising a forend and only one member, i.e. the deadbolt, may be arranged to protrude beyond the forend. The lock device may be of any type as described in published international patent application WO 2021058253 A1, the entirety of which is incorporated herein by reference.

According to a third aspect, there is provided a system comprising a lock device according to the second aspect and the strike having the strike opening.

The first ridge may be arranged to be separated from the first strike opening side when the at least one first inclined section contacts the first strike opening side. Conversely, the second ridge may be arranged to be separated from the second strike opening side when the at least one second inclined section contacts the second strike opening side.

The first strike opening side may comprise a recess for receiving the first ridge when the at least one first inclined section contacts the first strike opening side. The first ridge may be received in the recess without contacting a side of the recess when the deadbolt adopts the extended position.

The strike may comprise an inner strike plate having the strike opening and an outer strike plate for facing the lock device. In this case, the outer strike plate may comprise an auxiliary opening for receiving the deadbolt without contacting the deadbolt.

The outer strike plate may comprise aluminum. The outer strike plate may for example be made of aluminum. The inner strike plate may comprise steel. The inner strike plate may for example be made of steel.

### BRIEF DESCRIPTION OF THE DRAWINGS

Further details, advantages and aspects of the present disclosure will become apparent from the following description taken in conjunction with the drawings, wherein:

FIG. 1: schematically represents a frame, a door leaf and a system comprising a lock case and a strike;

FIG. 2: schematically represents a perspective view of a deadbolt of the lock case;

FIG. 3: schematically represents a first side view of the deadbolt;

FIG. 4: schematically represents a second side view of the deadbolt;

FIG. 5: schematically represents a top view of the deadbolt;

FIG. 6: schematically represents a front view of the deadbolt;

FIG. 7: schematically represents a perspective view of the system;

FIG. 8: schematically represents a partial front view of the lock case;

FIG. 9: schematically represents a partial perspective view of the strike;

FIG. 10: schematically represents a first partial cross-sectional top view of the system when the deadbolt is in an extended position;

FIG. 11: schematically represents a second partial cross-sectional top view of the system when the deadbolt is in the extended position;

FIG. 12: schematically represents a first partial cross-sectional top view of the system when the deadbolt is in a retracted position; and

FIG. 13: schematically represents a second partial cross-sectional top view of the system when the deadbolt is in the retracted position.

### DETAILED DESCRIPTION

In the following, a deadbolt for a lock device, a lock device comprising a deadbolt, and a system comprising a lock device and a strike, will be described. The same or similar reference numerals will be used to denote the same or similar structural features.

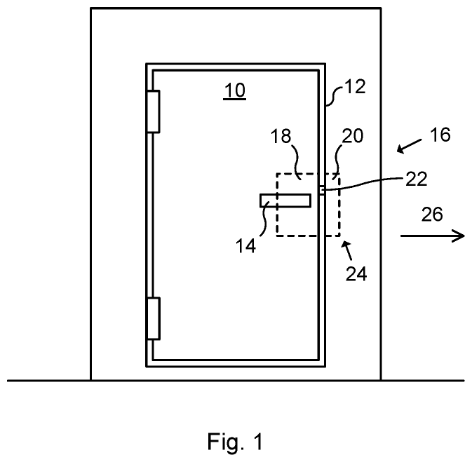

FIG. 1 schematically represents a door leaf 10 and a frame 12. The door leaf 10 is rotatable relative to the frame 12. In FIG. 1, the door leaf 10 is in a closed position. The door leaf 10 is one example of an access member according to the present disclosure. A handle 14 is provided on the door leaf 10. An opening torque can be provided by a human user to the handle 14. By turning the handle 14 and pulling, the door leaf 10 can be opened.

FIG. 1 further shows a system 16. The system 16 comprises a lock case 18 and a strike 20. The lock case 18 is one example of a lock device according to the present disclosure. The lock case 18 is installed in the door leaf 10. The strike 20 is installed in the frame 12.

The lock case 18 comprises a deadbolt 22. In FIG. 1, the deadbolt 22 is in an extended position 24 engaging the strike 20. The deadbolt 22 is movable from a retracted position to the extended position 24 in an actuating direction 26.

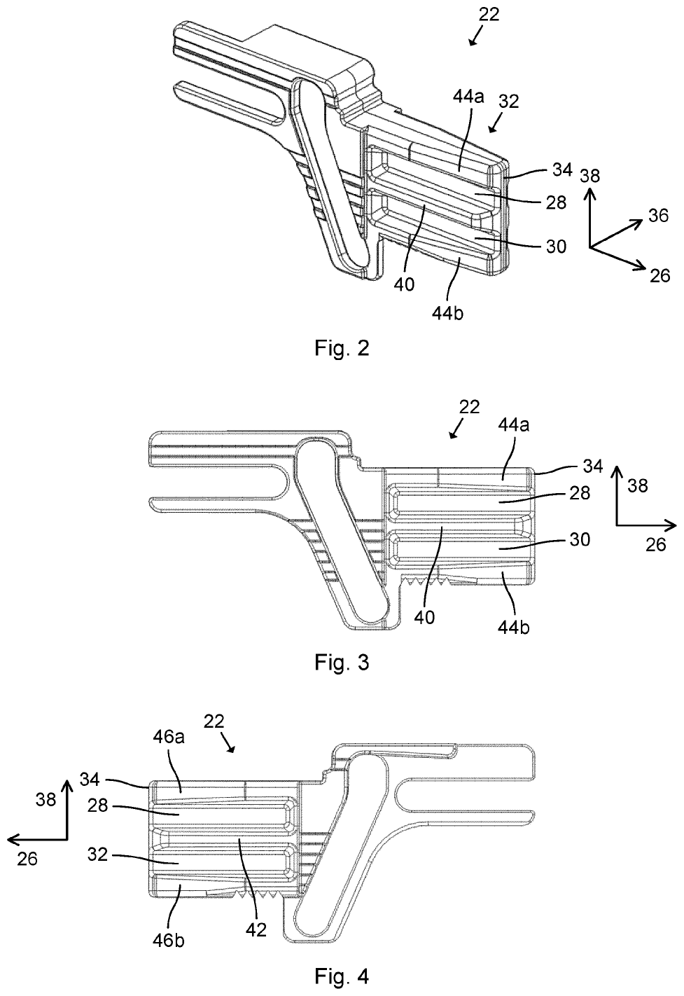

FIG. 2 schematically represents a perspective view of the deadbolt 22, FIG. 3 schematically represents a first side view of the deadbolt 22, and FIG. 4 schematically represents a second side view of the deadbolt 22. With collective reference to FIGS. 2 to 4, the deadbolt 22 of this example is made of steel. The deadbolt 22 comprises a base body 28. The base body 28 comprises a first base side 30 and a second base side 32 opposite to the first base side 30. The deadbolt 22 comprises an end 34 facing in the actuating direction 26.

FIG. 2 shows a transverse direction 36 transverse to the actuating direction 26. The actuating direction 26 and the transverse direction 36 may be referred to as an X-direction and a Y-direction, respectively. FIG. 2 further shows a Z-direction 38 perpendicular to each of the actuating direction 26 and the transverse direction 36. In use of the deadbolt 22 according to FIG. 1, the Z-direction 38 is vertical. In this example, the base body 28 has a main extension in a plane parallel with the actuating direction 26 and the Z-direction 38.

The deadbolt 22 further comprises a first ridge 40 and a second ridge 42. The first ridge 40 protrudes from the first base side 30. The second ridge 42 protrudes from the second base side 32. Each of the first ridge 40 and the second ridge 42 is parallel with the actuating direction 26.

The deadbolt 22 of this example further comprises two first inclined sections, here a primary first inclined section 44a and a secondary first inclined section 44b. The two first inclined sections 44a, 44b are parallel with each other and lie in a common plane. Each of the two first inclined sections 44a, 44b protrudes from the first base side 30. The first ridge 40 is here centered between the two first inclined sections 44a, 44b and separated in the Z-direction 38 from each of the two first inclined sections 44a, 44b. The first ridge 40 and the two first inclined sections 44a, 44b thus protrude separately from the first base side 30. Each of the two first inclined sections 44a, 44b is inclined towards the end 34.

Correspondingly, the deadbolt 22 of this example further comprises two second inclined sections, here a primary second inclined section 46a and a secondary second inclined section 46b. The two second inclined sections 46a, 46b are parallel with each other and lie in a common plane. Each of the two second inclined sections 46a, 46b protrudes from the second base side 32. The second ridge 42 is here centered between the two second inclined sections 46a, 46b and separated in the Z-direction 38 from each of the two second inclined sections 46a, 46b. The second ridge 42 and the two second inclined sections 46a, 46b thus protrude separately from the second base side 32. Each of the two second inclined sections 46a, 46b is inclined towards the end 34.

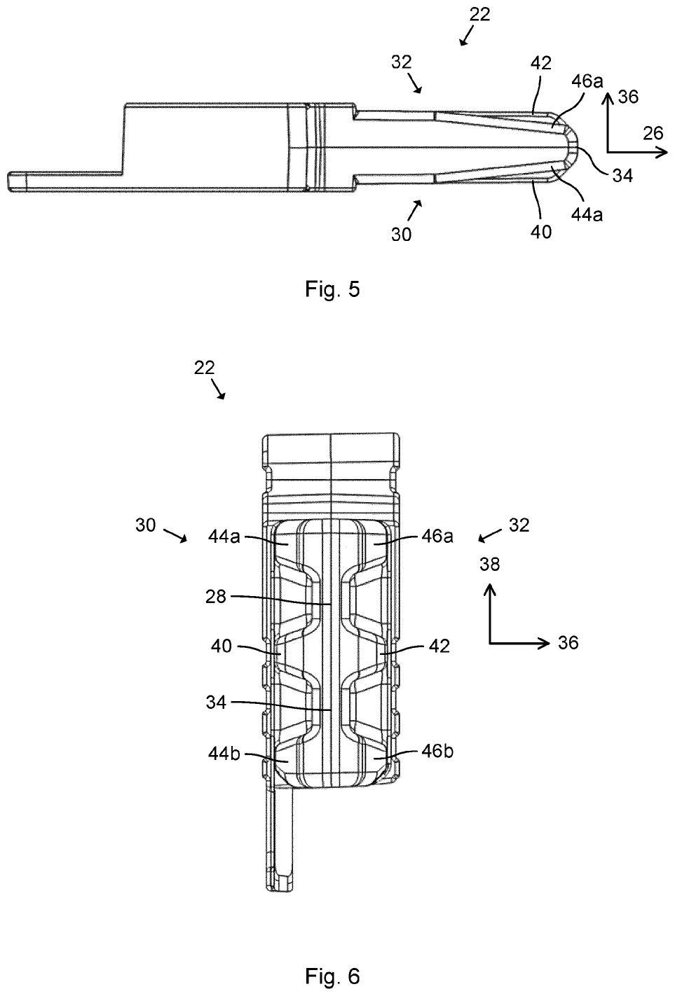

FIG. 5 schematically represents a top view of the deadbolt 22. As can be gathered from FIG. 5, each of the first and second inclined sections 44a, 44b, 46a, 46b is inclined approximately 6 degrees to the actuating direction 26 in a plane comprising the actuating direction 26 and the transverse direction 36.

FIG. 6 schematically represents a front view of the deadbolt 22. As shown in FIG. 6, the primary first inclined section 44a is aligned with and opposite to the primary second inclined section 46a, the first ridge 40 is aligned with and opposite to the second ridge 42, and the secondary first inclined section 44b is aligned with and opposite to the secondary second inclined section 46b.

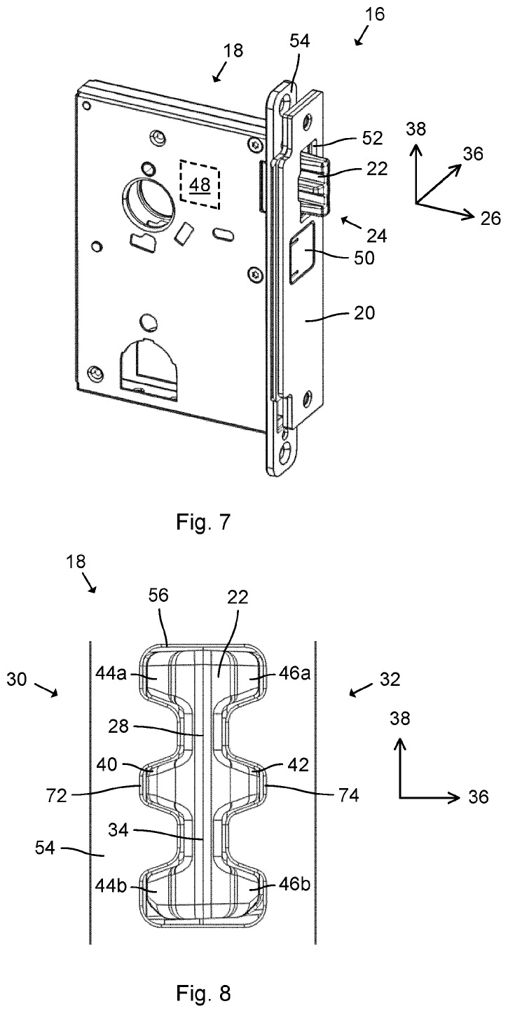

FIG. 7 schematically represents a perspective view of the system 16. The lock case 18 of this example is a single bolt lock device. The lock case 18 comprises a deadbolt force device 48, here exemplified as a spring. The deadbolt force device 48 is arranged to force the deadbolt 22 from the retracted position towards the extended position 24. FIG. 7 further shows that the strike 20 of this example comprises a magnet 50. The magnet 50 may cooperate with the lock case 18 to trigger release of the deadbolt 22 when the door leaf 10 comes close to the frame 12 during a closing movement. The functionality of the release of the deadbolt 22 may for example be as described in published international patent application WO 2021058253 A1.

The strike 20 comprises a strike opening 52. In the extended position 24, the deadbolt 22 protrudes through the strike opening 52.

FIG. 8 schematically represents a partial front view of the lock case 18. The lock case 18 comprises a forend 54 and a lock device opening 56. The lock device opening 56 is in this example provided in the forend 54. The lock device opening 56 of this example generally conforms to the profile of the deadbolt 22. However, plays between the first and second ridges 40, 42 and the sides of the lock device opening 56 are smaller than plays between the inclined sections 44a, 44b, 46a, 46b and the sides of the lock device opening 56.

In FIG. 8, the deadbolt 22 is centered with respect to the lock device opening 56 in the transverse direction 36 and the Z-direction 38. However, in use, the deadbolt 22 may move slightly within the lock device opening 56.

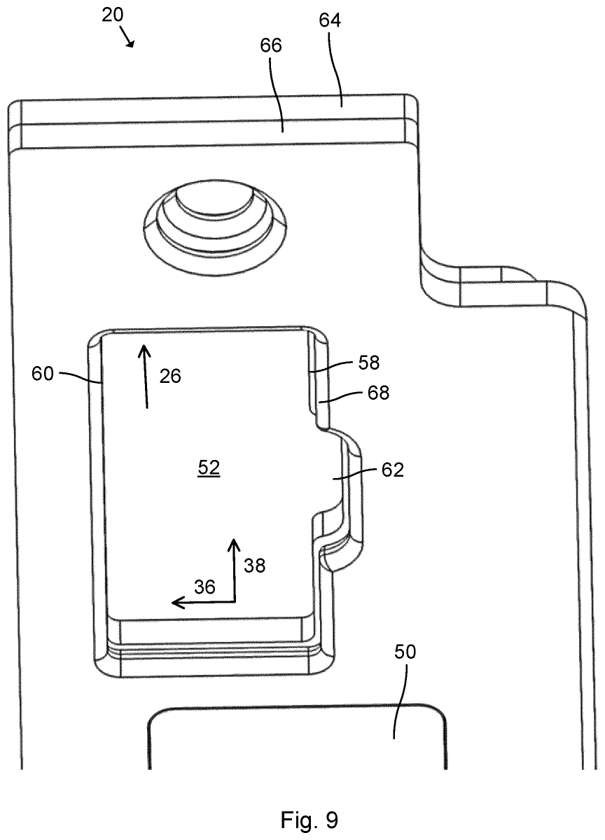

FIG. 9 schematically represents a partial perspective view of the strike 20. The strike opening 52 comprises a first strike opening side 58 and a second strike opening side 60 opposite to the first strike opening side 58. The strike opening 52 further comprises a recess 62 in the first strike opening side 58.

In this specific and non-limiting example, the strike 20 comprises an inner strike plate 64 and an outer strike plate 66. When the door leaf 10 is in the closed position, the outer strike plate 66 is positioned between the lock case 18 and the inner strike plate 64. In this example, the strike opening 52 is provided in the inner strike plate 64. The outer strike plate 66 comprises an auxiliary opening 68 that is larger than the strike opening 52. In contrast to the strike opening 52, the auxiliary opening 68 is not intended to be contacted by the deadbolt 22. In this example, the inner strike plate 64 is made of steel and the outer strike plate 66 is made of aluminum.

As can be gathered from FIGS. 7 and 9, the magnet 50 is accommodated in respective openings in the inner strike plate 64 and the outer strike plate 66. In this example, the magnet 50 is secured to the inner strike plate 64 and is flush with a side of the outer strike plate 66 facing the forend 54.

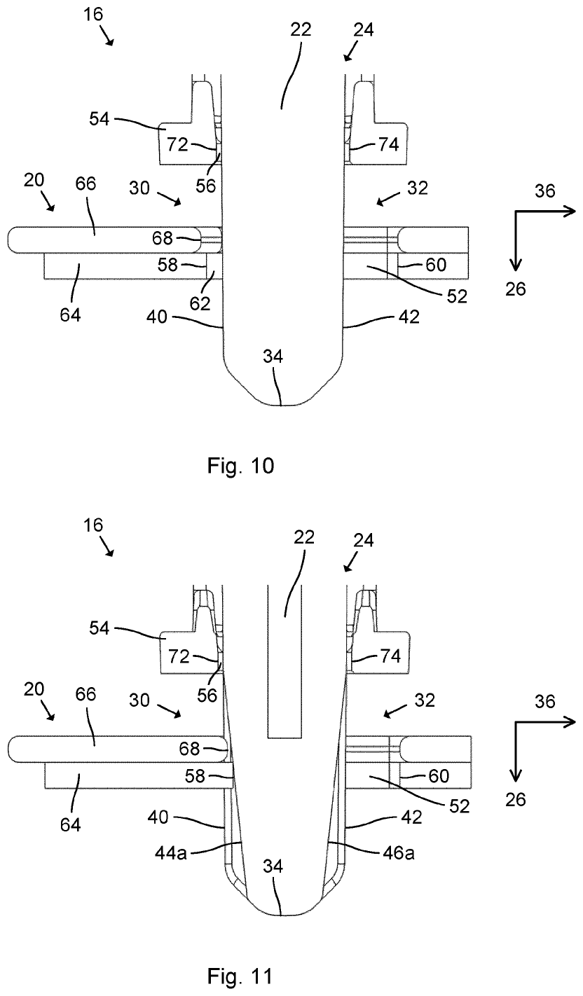

FIG. 10 schematically represents a first partial cross-sectional top view of the system 16 when the deadbolt 22 is in the extended position 24, and FIG. 11 schematically represents a second partial cross-sectional top view of the system 16 when the deadbolt 22 is in the extended position 24. With collective reference to FIGS. 10 and 11, the lock device opening 56 comprises a first lock device opening side 72 and a second lock device opening side 74 opposite to the first lock device opening side 72. In case the deadbolt 22 moves slightly in the transverse direction 36 when moving in the actuating direction 26 from the retracted position 70 to the extended position 24, only the first and/or second ridge 40, 42, but not any of the inclined sections 44a, 44b, 46a, 46b, will contact the forend 54 and frictionally slide against the forend 54. As shown, the primary first inclined section 44a (and also the secondary first inclined section 44b) is in frictional contact with the first strike opening side 58 but none of the first and second ridges 40, 42 contacts the strike 20. The deadbolt 22 does however not contact the outer strike plate 66. The outer strike plate 66 can therefore be designed to be aesthetically pleasing.

In this example, the first ridge 40 is received in the recess 62 when the deadbolt 22 moves in the strike 20. Due to the frictional sliding between the first inclined section 44a and the first strike opening side 58, the first inclined section 44a is able to force the deadbolt 22 further into the strike 20, yet blocks opening of the door leaf 10 by pulling it. Since both the deadbolt 22 and the inner strike plate 64 are made of steel, a low friction coefficient is provided. In the extended position 24, the deadbolt 22 protrudes approximately 2.5 cm from the forend 54.

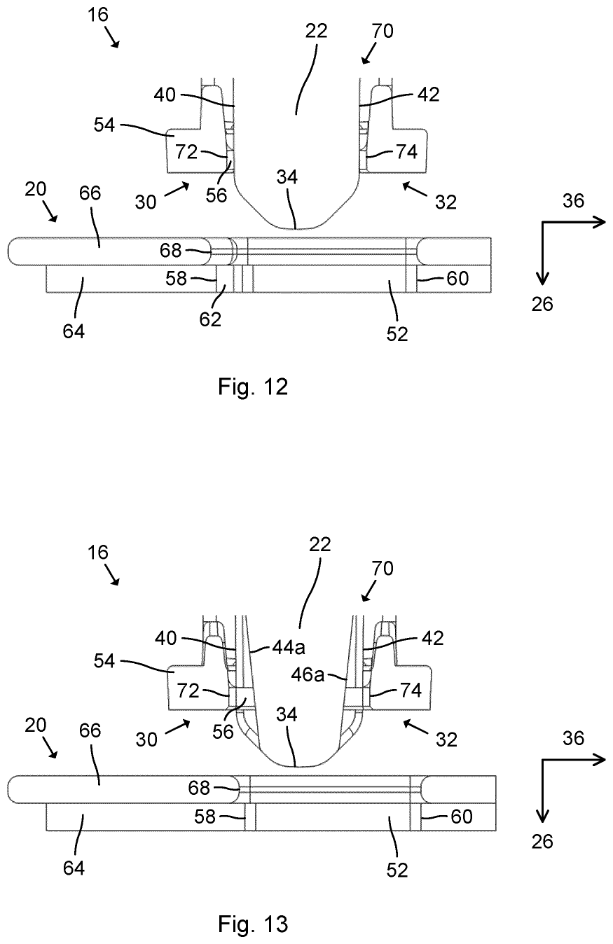

FIG. 12 schematically represents a first partial cross-sectional top view of the system 16 when the deadbolt 22 is in a retracted position 70, and FIG. 13 schematically represents a second partial cross-sectional top view of the system 16 when the deadbolt 22 is in the retracted position 70. With collective reference to FIGS. 12 and 13, an opening torque has been applied to the handle 14 to retract the deadbolt 22. In the retracted position 70 of the deadbolt 22, the door leaf 10 can be opened. In case the deadbolt 22 in the retracted position 70 is slightly displaced in the transverse direction 36, either the first ridge 40 will contact the first lock device opening side 72 or the second ridge 42 will contact the second lock device opening side 74. The first ridge 40 will contact the first lock device opening side 72 without the possibility that any of the first inclined sections 44a, 44b contacts the first lock device opening side 72 during displacement of the deadbolt 22 to the left (in FIGS. 12 and 13) in the transverse direction 36. Conversely, the second ridge 42 will contact the second lock device opening side 74 without the possibility that any of the second inclined sections 46a, 46b contacts the second lock device opening side 74 during displacement of the deadbolt 22 to the right (in FIGS. 10 and 11) in the transverse direction 36. Alternatively, both the first ridge 40 and the second ridge 42 may always be in contact with the first lock device opening side 72 and the second lock device opening side 74, respectively, in each of the retracted position 70 and the extended position 24. In these manners, frictional forces between the deadbolt 22 and the forend 54 are reduced when retracting the deadbolt 22, the deadbolt 22 can be guided stably, and the opening torque applied to the handle 14 can be significantly reduced. A reverse procedure takes place when the deadbolt 22 is extended.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1-15. (canceled)

16. A deadbolt for a lock device, for moving in an actuating direction in a lock device opening of the lock device and into a strike opening of a strike, the deadbolt comprising:
a base body having a first base side, a second base side opposite to the first base side, and an end for facing the strike opening;
a first ridge for frictionally sliding against a first lock device opening side of the lock device opening, the first ridge protruding from the first base side and being parallel with the actuating direction;
a second ridge for frictionally sliding against a second lock device opening side of the lock device opening, the second ridge protruding from the second base side and being parallel with the actuating direction;
at least one first inclined section for frictionally sliding against a first strike opening side of the strike opening, the at least one first inclined section protruding from the first base side separately from the first ridge and being inclined towards the end; and
at least one second inclined section for frictionally sliding against a second strike opening side of the strike opening, the at least one second inclined section protruding from the second base side separately from the second ridge and being inclined towards the end.

17. The deadbolt according to claim 16, wherein each of the at least one first inclined section and the at least one second inclined section is inclined less than 40 degrees to the actuating direction in a plane comprising the actuating direction and a transverse direction transverse to the actuating direction.

18. The deadbolt according to claim 16, wherein the at least one first inclined section comprises two first inclined sections.

19. The deadbolt according to claim 18, wherein the first ridge is positioned between the two first inclined sections.

20. The deadbolt according to claim 16, wherein the deadbolt comprises steel.

21. A lock device for installation in an access member movable relative to a frame, the frame comprising the strike according to claim 16 and the lock device comprising the lock device opening and the deadbolt according to claim 16.

22. The lock device according to claim 21, further comprising a forend, wherein the lock device opening is provided in the forend.

23. The lock device according to claim 21, wherein the at least one first inclined section is arranged to be separated from the first lock device opening side when the first ridge contacts the first lock device opening side.

24. The lock device according to claim 21, wherein the deadbolt is movable between an extended position for engagement with the strike and a retracted position for disengagement from the strike, and wherein the lock device further comprises a deadbolt force device arranged to force the deadbolt from the retracted position towards the extended position.

25. The lock device according to claim 21, wherein the strike comprises steel.

26. A system comprising a lock device and the strike according to claim 21.

27. The system according to claim 26, wherein the first ridge is arranged to be separated from the first strike opening side when the at least one first inclined section contacts the first strike opening side.

28. The system according to claim 27, wherein the first strike opening side comprises a recess for receiving the first ridge when the at least one first inclined section contacts the first strike opening side.

29. The system according to claim 26, wherein the strike comprises an inner strike plate having the strike opening and an outer strike plate for facing the lock device, and wherein the outer strike plate comprises an auxiliary opening for receiving the deadbolt without contacting the deadbolt.

30. The system according to claim 29, wherein the outer strike plate comprises aluminum.
